(19) United States
(12) Patent Application Publication
(10) Pub. No.: US 2009/0010518 A1
(43) Pub. Date: Jan. 8, 2009

(54) METHOD FOR RECONSTRUCTION OF COMPUTED TOMOGRAPHY REPRESENTATIONS FROM X-RAY CT DATA SETS OF AN EXAMINATION SUBJECT WITH SPIRAL SCANNING

(76) Inventors: Harald Schoendube, Erlangen (DE); Frederic Noo, Midvale, UT (US); Karl Stierstorfer, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 12/166,799

(22) Filed: Jul. 2, 2008

Related U.S. Application Data
(60) Provisional application No. 60/958,088, filed on Jul. 2, 2007.

(51) Int. Cl. G06K 9/00

(52) U.S. Cl. 382/131

(57) ABSTRACT

The image reconstruction is implemented along theoretical π-lines, wherein the theoretical π-lines not only lead to interpolated detector data but also can emanate from interpolated source positions. Interpolation thus occurs both at the detector and at the source.

### RELATED APPLICATION

The present application claims the benefit of the filing date of provisional application 60/958,088, filed on Jul. 2, 2007.

### BACKGROUND OF THE INVENTION

1. Field of the Invention

The present invention concerns a method for reconstruction of computed tomography (CT) representations from x-ray CT data sets of an examination subject, of the type wherein scanning of the examination subject ensues on a spiral helical path and, for reconstruction, a differential backprojection is implemented, followed by a Hilbert transformation over a surface formed by π-lines.

2. Description of the Prior Art

Differential backprojection (DBP) followed by a Hilbert transformation is generally known in connection with a CT spiral scan for reconstruction of computed tomography representations from x-ray CT data sets of an examination subject along lines known as π-lines, which are straight lines that intersect the spiral path twice at a distance of less than one full revolution. Such reconstruction is described in J. Pack, F. Noo and R. Clackdoyle, “Cone-beam reconstruction using the backprojection of locally filtered projections”, IEEE Trans. Med. Imag., vol. 24, no. 1, pp. 70-85, January 2005. In the known methods, the reconstruction always occurs along π-lines that lie on actual measured beam positions. This makes the method relatively inflexible.

### SUMMARY OF THE INVENTION

An object of the present invention is to provide an improved and more flexible method for reconstruction of CT representations making use of π-lines.

The method, CT apparatus and computer-readable medium in accordance with the invention are based on the insight that it is advantageous when the conventional limitation of the conducted reconstruction to actually measured beam paths is abolished. According to the invention, this can occur by arbitrary virtual beams being interpolated with the use of actual measured, adjacent beams.

Therefore, in accordance with the invention, in a method for reconstruction of computer tomography representations from x-ray CT data sets of an examination subject, scanning of the examination subject ensues on a spiral path and, for reconstruction, a differential backprojection (DBP) is conducted followed by a Hilbert transformation over a surface formed by π-lines, and interpolated detector data are used for the reconstruction.

The spiral path is provided by a(λ)=[R₀ cos(λ+λ₀),R₀ sin(λ+λ₀),z₀+hλ], wherein λ serves as a free index, R₀ stands for the spiral path radius and h represents the table feed per spiral revolution. λ₀ and z₀ indicate the position of the x-ray source for the index λ=0.

It is advantageous when the detector data are interpolated between actual measured detector data, such that the associated π-lines are combined into a number of surfaces on which the π-lines respectively appear in parallel, projected on a plane perpendicular to a z-axis (=system axis) of a CT system used for examination. The interpolated detector data can be selected to form the π-lines, such that the projections of the π-lines are equidistantly formed on the (x,y) plane in a Cartesian (x,y,z) coordinate system. It should be noted that π-lines whose projections lie parallel to the (x,y) plane do not, by design, run parallel relative to the z-axis.

The individual surfaces that are formed from π-lines in this manner are indexed across the central π-line on this surface (thus the π-line that intersects the z-axis), and in fact across the first intersection point a(λ_{filt}) of the source trajectory with this π-line. Each λ_{filt} thus uniquely designates a surface of π-lines.

To reconstruct a volume described in classical (x,y,z) coordinates, it is necessary to initially cover this volume with surfaces of therefore π-lines over a sufficient range of filt.

Two fundamental preferred embodiments are possible in the method according to the invention for reconstruction of the object function on these surfaces, namely:

(A) Backprojection is conducted on a (s,τ)-grid rotated with λ_{filt} in a cylindrical (s,τ,λ_{filt})-coordinate grid, wherein the final reconstruction occurs via application of the inverse Hilbert transformation in the same geometry, and the results are subsequently interpolated on a Cartesian (x,y,z) coordinate grid with:

s=−x sin(λ_{filt}+λ₀)+y cos(λ_{filt}+λ₀)

τ=−x cos(λ_{filt}+λ₀)−y sin(λ_{filt}+λ₀)

x,y,z=the Cartesian coordinates,

wherein the following relationship exists between the coordinates:

$$x = - s sin ( {λ}_{filt} + {λ}_{0} ) - τ cos ( {λ}_{filt} + {λ}_{0} ) , \\ y = s cos ( {λ}_{filt} + {λ}_{0} ) - τ sin ( {λ}_{filt} + {λ}_{0} ) , \\ z = {z}_{0} + h ( {λ}_{filt} + \frac{π}{2} + k ( s , τ ) ) , \\ with$$

$$k ( s , τ ) = \frac{τ ( π / 2 - arcsin ( s / {R}_{0} ) )}{\sqrt{{R}_{0}^{2} - {s}^{2}}}$$

and
R₀ is the radius of the spiral path
or
(B) the backprojection is executed on the surface of the π-lines across an (x,y)-grid in an (x,y, λ_{filt})-coordinate grid, the backprojection results are interpolated in a cylindrical (s,τ, λ_{filt})-coordinate grid in order to implement the inverse Hilbert transformation, and the results are subsequently interpolated on a Cartesian (x,y,z) coordinate grid with:

s=−x sin(λ_{filt}+λ₀)+y cos(λ_{filt}+λ₀)

τ=−x cos(λ_{filt}+λ₀)−y sin(λ_{filt}+λ₀)

x,y,z=the Cartesian coordinates,

wherein the following relationship likewise exists between the coordinates:

$$x = - s sin ( {λ}_{filt} + {λ}_{0} ) - τ cos ( {λ}_{filt} + λ ) , \\ y = s cos ( {λ}_{filt} + {λ}_{0} ) - τ sin ( {λ}_{filt} + λ ) , \\ z = {z}_{0} + h ( {λ}_{filt} + \frac{π}{2} + k ( s , τ ) ) , \\ with$$

$$k ( s , τ ) = \frac{τ ( π / 2 - arcsin ( s / {R}_{0} ) )}{\sqrt{{R}_{0}^{2} - {s}^{2}}}$$

and
R₀ is the radius of the spiral path.

In both embodiments A) and B), three different variants can be used. These are:

(a) a variant in which the derivations necessary for the DBP are effected exclusively in detector coordinates,
(b) a variant in which the DBP is implemented with the aid of a derivation according to the source position A given a fixed beam direction in space,
(c) a variant in which a rebinning in the pseudo-parallel rebinning geometry (=“wedge” geometry) that is defined by the following equations

$$( λ , γ ) = λ + \frac{π}{2} - γ , \qquad {s}_{r} ( λ , γ ) = {R}_{0} sin γ$$

initially occurs before the backprojection. The derivation and backprojection can subsequently be conducted in this geometry.

### BRIEF DESCRIPTION OF THE DRAWINGS

FIG. 1 schematically illustrates the geometry of data acquisition in accordance with the invention;

FIG. 2 schematically illustrates the reconstruction geometry in accordance with the invention;

FIG. 3 is a block diagram of a CT system to implement the method according to the invention.

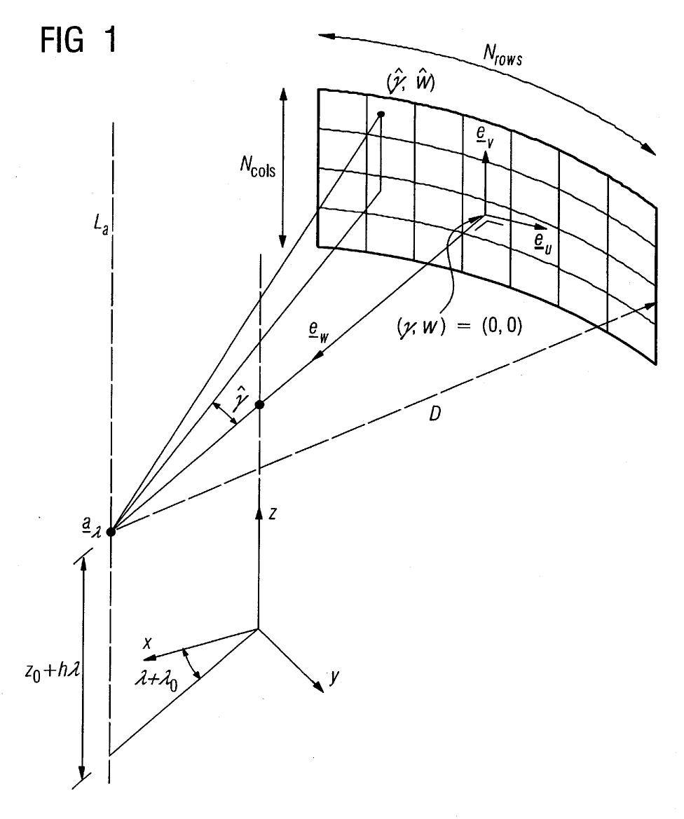

In the following the invention is described in detail with the use of FIGS. 1, 2 and 3, wherein only the features necessary for understanding the invention are shown. The following reference characters and variables are used:
1: CT system;
2: first x-ray tube;
3: first detector;
4: second x-ray tube;
5: second detector;
6: gantry housing;
7: patient;
8: examination bed;
9: system axis;
10: control and computation unit;
11: memory;
α(?): spiral path;
α(λ,y,w): unit vector of α(λ) in the direction of the detector element at the point (γ,w);
C(x): auxiliary function;
D: distance of Lₐ from the detector;
eₛ(λ_{filt}): defined in Equation 8;
eₜ: unit vector along the π-lines;
e_{T}(λ_{filt}): defined in Equation 9;
eᵤ: unit vector;
eᵤ(λ): unit vector along the detector rows;
eᵥ(λ): unit vector along the detector columns;
e_{w}(λ): unit vector from the detector center in the direction of the x-ray tube;
f(x): density of the examination subject at a location x;
\hat{f}(x+tα): reconstruction of the examination subject a the location (x+tα) with a free variable t;
\hat{f}(x): final reconstruction;
g_{rebin}(∂,sᵣ,w): CT raw data after rebinning according to Equation 19;
g̅_{rb}(∂,sᵣ,w): filtered, rebinned CT raw data according to Equation 21;
g_{F}(λ,γ, w): filtered CT raw data according to Equation 18;
g̅(λ,γ, w): weighted CT raw data;
h: table feed per spiral revolution, divided by 2*π;
Hf: Hilbert-transformation of f;
(Hf)(x): result of the backprojection;
(Hf)(x+t′a): Hilbert-transformation of f at the point x+t′a;
Lₐ: line parallel to the axis through a(λ);
Prg₁-Prgₙ: computer program code;
R₀: radius of the spiral path;
s: coordinate transversal to the π-line;
sᵣ*(∂,x): w-coordinate of the projection of the point x in rebinned geometry at the projection angle ∂;
sᵣ(λ,γ): rebinning coordinate according to Equation 19;
t: coordinate along to the π-line;
V: volume;
Δz: voxel size in the z-direction;
w: detector coordinates along the detector columns;
ŵ: λ-coordinate of an arbitrary detector element;
w*(λ,x): λ-coordinate of the projection of the point x starting from the detector position a(λ_{q});
w*(λ,x): λ-coordinates of the projection of the point x starting from the detector position a(λ_{q});
w*(λ,x): λ-coordinates of the projection of the point x in rebinned geometry at the projection angle ∂;
wₜₒₚ: upper bound of the Tam-Danielsson (=TD) window;
w_{bottom}: lower bound of the TD window;
x, y, z: Cartesian coordinates;
z₀: start position of the tube in the z-direction;
\hat{γ}: γ coordinates of an arbitrary detector element;
γ*(λ,x): γ coordinates of the projection of the point x starting from the detector position a(λ);
η(λ,x): auxiliary function defined in Equation 15;
∂(λ,γ): rebinning coordinates according to Equation 19;
λ: rotation angle;
λ₀: start angle;
λ₁(x): first intersection point of the π-line through x with the spiral path;
λ₂(x): second intersection point of the π-line through x with the spiral path;
λ_{q}: placeholder for λ₁ and λ₂ in Equation 18;
λ_{filt}: spiral position of the surface of the π-lines;
Δλ_{filt}: interval of the π-line surfaces;
τ: coordinates along the projection of the π-lines on the x-y plane.

### DESCRIPTION OF THE PREFERRED EMBODIMENTS

An implementation procedure is described for an effective two-step Hilbert reconstruction employing a differential backprojection (DBP) followed by an inverse Hilbert transformation (HT) on π-lines. This procedure is adapted to data sets that originate from curved detectors and are based on a reconstruction along theoretical π-lines. By theoretical π-lines, what is understood is a subset of the infinite set of π-lines which would be measured in a continuous measurement system. In contrast to real π-lines which exclusively represent those lines in space along which actual projections were obtained. This selection enables a free variation of the reconstruction grid within the x,y-plane.

Six different variations are within the scope of this implementation procedure. In the following, these six variants of the algorithm are described with their advantages and disadvantages.

### Geometry

The revolution path is provided by the equation

a(λ)=[R₀ cos(λ+λ₀),R₀ sin(λ+λ₀),z₀+hλ], EQ 1

wherein λ describes the rotation angle of the source in the interval [0,λₘₐₓ], R₀ describes the spiral radius and 2πh describes the spiral advance. The revolution path is determined by λ₀ and z₀ such that, at λ=0, the source is positioned at the angle λ₀ in the plane z=z₀.

In contrast to the standard (x,y,z)-geometry, a rotating coordinate system is thus used which moves with the detector system corresponding to FIG. 1. The orthonormal basis of this coordinate system is provided by the vectors

eᵤ(λ)=[−sin(λ+λ₀),cos(λ+λ₀),0] EQ. 2

eᵥ=[0,0,1] EQ. 3

e_{w}(λ)=[cos(λ+λ₀),sin(λ+λ₀),0]. EQ. 4

The detector consists of a field of N_{rows}×N_{cols} elements which are arranged in columns parallel to the unit vector eᵥ and form arcs line-by-line through the spiral point around a line Lₐ parallel to the z-axis. It is thereby counted in the direction of the unit vectors eᵤ and e_{w}, wherein the detector units are described by the angle γ and the detector row index w while the detector does not completely lie in the plane that is formed by the unit vectors eᵤ and eᵥ. Furthermore, the distance from the line Lₐ through the focus towards the detector is designated with D, and the density of the three-dimensional examination subject is designated with f(x).

In the present notation, the measurements are described with:

$$\begin{matrix}g ( λ , γ , w = {\int }_{0}^{∞} f ( \underline{α} ( λ ) + t \underline{α} ( λ , γ , w ) ) d t ) \\ with & EQ . 5 \\ α ( λ , γ , w ) = \frac{( D sin γ {\underline{e}}_{u} ( λ ) - D cos γ {\underline{e}}_{w} ( λ ) + {we}_{v} )}{\sqrt{{D}^{2} + {w}^{2}}} . & EQ . 6\end{matrix}$$

A change of the standard (x,y,z)-geometry is required for the backprojection so that sets of parallel, theoretical π-lines can be worked with. We limit ourselves (without limiting the generality) to π-lines which exhibit a positive slope and form surfaces of π-lines that cover the desired reconstruction volume.

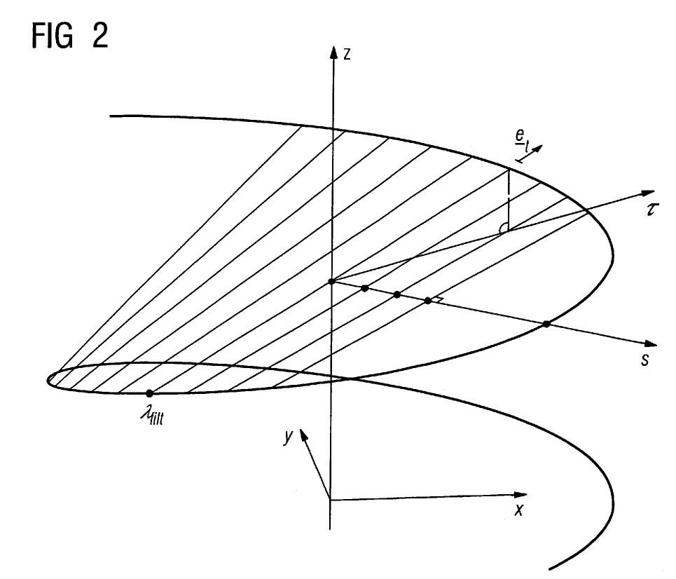

FIG. 2 shows such a surface. Each surface is indexed by a spiral position π_{filt}, wherein a(λ_{filt}) describes the start point of any π-line on a given surface which intersects the z-axis. All π-lines on a given surface are parallel in relation to their projections on the x,y-plane. λ_{filt} thus describes the direction of these lines and thereby uniquely defines a surface of π-lines. It should be noted that by design each π-line intersects the spiral path twice, and that such defined π-lines with the same λ_{filt} do not lie in parallel in the z-dimension.

A surface of π-lines (as is shown in FIG. 2) correspondingly does not define a plane but rather a curved surface in space. In spite of this, a reconstruction with the aid of these surfaces can be implemented using a cleaner interpolation.

For indexing on each π-line surface, s,τ-coordinates are used that are obtained by rotating the x- and y-coordinates corresponding to Equations 8 and 9:

eₛ(λ_{filt})=[−sin(λ_{filt}+λ₀),cos(λ_{filt}+λ₀),0] EQ. 8

eᵣ(λ_{filt})=[−cos(λ_{filt}+λ₀),sin(λ_{filt}+λ₀),0]. EQ. 9

In other words, s describes the distance of projections of the π-lines on the x-y-plane from the origin and τ is a coordinate along these projections. Furthermore, a variable t along the π-lines is introduced, wherein the projection of t on the x-y-plane corresponds to the variable τ. The z-position at a point indexed by s,τ,λ_{filt} is thus provided by:

$$z = {z}_{0} + h ( {λ}_{filt} + \frac{π}{2} + \frac{τ ( π / 2 - arcsin ( s / {R}_{0} )}{\sqrt{{R}_{0}^{2} - {s}^{2}}} ) . \qquad EQ . 10$$

For a volume V to be reconstructed in Cartesian coordinates, this equation allows us to determine the range of λ_{filt} over which the backprojection should be executed in order to completely cover the volume V. The distance between the surfaces of the π-lines over which the backprojection is executed is then described with:

Δλ_{filt}=Δz/h, EQ. 11

wherein Δz corresponds to the desired voxel size in the z-direction.

The backprojection grid can be arranged in two different ways:
1) The grid is placed over an arbitrary s,τ-grid and the backprojection is placed directly into this s,τ,λ_{filt}-coordinate system. The final reconstruction is then implemented via application of the inverse Hilbert transformation in the same geometry and corresponding interpolation into the x,y,z-grid.
2) The backprojection occurs on the surface of the theoretical π-lines, however the grid is designed on an x,y-grid with a resulting x,y, λ_{filt}-coordinate system. The backprojection result is then interpolated on the s,τ,λ_{filt}-system for the inverse Hilbert transformation and subsequently repeatedly interpolated on the x,y,z-grid.

The second method has the advantage that the x,y-positions of the voxels to be reconstructed do not change over λ_{filt}, whereby the backprojection is accelerated; however, an influence (corresponding to the additional interpolation that is required for the inverse Hilbert transformation) can be exerted on the image quality, which must be correspondingly monitored.

### Algorithms and Implementation Strategies

In contrast to the standard approach of a filtered backprojection (FBP), the result of a differentiated backprojection (DBP) is not a theoretically exact reconstruction of f(x) but rather instead of this the Hilbert transformation of f(x) along the π-lines described above. The implementation of a two-step Hilbert reconstruction thus contains finding a good way to apply an inverse Hilbert transformation to backprojection results. One method for this is already described by F. Noo et al. in “A two-step Hilbert transform method for 2D image reconstruction”, Phys. Med. Biol. vol. 49, pp. 39093-3923, 2004. In the following the result of the backprojection is designated as (Hf)(x) and the final reconstruction is designated as \hat{f}(x).

As presented by S. G. Mikhlin in “Integral equations and their applications to certain problems in Mechanics, Mathematical Physics and Technology”, New York: Pergamon, 1957, pp. 126-131, an inverse Hilbert transformation along the direction of a unit vector a can be achieved for a function with limited definition range via the use of

$$\hat{f} ( \underline{x} + t \underline{α} ) = \frac{- 1}{\sqrt{( t - {t}_{min} ) ( {t}_{max - t} )}} [ C ( \underline{x} ) + {\int }_{{t}_{min}}^{{t}_{max}} \frac{( Hf ) ( \underline{x} + {t}^{′} α )}{t - {t}^{′}} \sqrt{( {t}^{′} - {t}_{min} ) ( {t}_{max}^{′} - t ) d {t}^{′}} ] , \qquad EQ . 12$$

wherein f(x+tα)≡0 for t∉(tₘᵢₙ,tₘₐₛ). The function C(x) can be calculated in different ways. These are, for example, described by J. Pack et al. in “Cone-beam reconstruction using the backprojection of locally filtered projections”, IEEE Trans. Med. Imag., vol. 24, no. 1, pp. 70-85, January 2005; L. Yu et al., “A rebinning-type backprojection-filtration algorithm for image reconstruction in helical cone-beam CT” in Proc. 2006 IEEE Medical Image Conference (San Diego, Calif.), 2006; and F. Noo et al., “A two-step Hilbert transform method for 2D image reconstruction”, Phys. Med. Biol. vol. 49, pp. 39093-3923, 2004. For our implementation, the simplest way to describe the C(x) function was found with:

$$C ( \underline{x} ) = - \frac{2 \cdot {\int }_{- ∞}^{∞} f ( \underline{x} + t \underline{α} ) d t}{π} , \qquad EQ . 13$$

since this value can be obtained directly from the measurement data. Equation 12 can now be implemented in Equation 13. The way for this is shown by, for example, J. Pack et al. in “Cone-beam reconstruction using the backprojection of locally filtered projections”, IEEE Trans. Med. Imag., vol. 24, no. 1, pp. 70-85, January 2005 or by F. Noo et al. in “A two-step Hilbert transform method for 2D image reconstruction”, Phys. Med. Biol. vol. 49, pp. 39093-3923, 2004, wherein a rectangular overlap weighting window with a half-pixel shift relative to the initial data is used to avoid aliasing artifacts.

The different variants of the implementation of the differential backprojection in this task can be subdivided into three classes:
1) Derivation exclusively in reference to the detector coordinates. Since this method entails a backprojection with a square root distance weighting, it is subsequently described with “DBP-2”.
2) Derivation of the measurement data relative to A given a fixed beam direction. This method requires no square root in the backprojection weighting and is therefore designated “DBP-1”.
3) Rebinning of the data on a pseudo-parallel conical beam (“wedge”) geometry and subsequent differentiation and backprojection in this geometry. This method requires no backprojection weighting and is therefore called “DBP-0”.

Together with the two different methods for generation of the backprojection grids, in total six different versions of the described two-step Hilbert reconstruction method are obtained with differential backprojection and subsequent inverse Hilbert transformation. The different DBP variants used here are subsequently described in detail with regard to their implementation.
1) DBP-2:
   The implementation of DBP is presented in principle by J. Pack et al. in “Cone-beam reconstruction using the backprojection of locally filtered projections”, IEEE Trans. Med. Imag., vol. 24, no. 1, pp. 70-85, January 2005. The differentiation is implemented exclusively in detector coordinates, and a backprojection weighting of the square root of the distance between voxels and the spiral point is used, projected on an x,y-surface.

$$( Hf ) ( \underline{x} ) = - \frac{1}{2 π} [ \begin{matrix}{\sum }_{q - 1}^{2} \frac{{( - 1 )}^{q} g ( {λ}_{q} , {γ}^{*} ( {λ}_{q} , \underline{x} ) , {w}^{*} ( {λ}_{q} , \underline{x} ) )}{‖ x - \underline{α} ( {λ}_{q} ) ‖} + \\ {\int }_{{λ}_{1} ( \underline{x} )}^{{λ}_{2} ( \underline{x} )} \frac{{D}_{gF} ( λ , {γ}^{*} ( λ , \underline{x} ) , {w}^{*} ( λ , \underline{x} ) )}{{η ( λ , \underline{x} )}^{2}} d λ\end{matrix} ] \qquad EQ . 13$$

applies for a curved detector geometry, with A₁(x) and A₂(x) as the first and second intersection point of the π-line through (x) with the spiral path and

$$\begin{matrix}η ( λ , \underline{x} ) = {R}_{0} - x cos ( λ + {λ}_{0} ) - y sin ( λ + {λ}_{0} ) & EQ 15 \\ {γ}^{*} ( λ , \underline{x} ) = arctan ( \frac{y cos ( λ + {λ}_{0} ) - x sin ( λ + {λ}_{0} )}{η ( λ , \underline{x} )} ) & EQ . 16 \\ {ω}^{*} ( λ , \underline{x} ) = \frac{D cos ( {γ}^{*} ( λ , \underline{x} ) )}{η ( λ , \underline{x} )} ( z - {z}_{0} - h λ ) \\ and & EQ . 17 \\ {g}_{F} ( λ , γ , w ) = {R}_{0} \frac{{cos}^{2} γ}{D} \frac{\partial \overline{g}}{\partial γ} + cos γ ( h - {R}_{0} w \frac{sin γ}{D} ) \frac{\partial g}{\partial ω} , \\ wherein \overline{g} = \overline{g} ( λ , γ , w ) = ( D / \sqrt{{D}^{2} + {w}^{2}} ) g ( λ , γ , w ) . & EQ . 18\end{matrix}$$

The z-values of each voxel on the desired s,τ-grid or x,y-grid are first calculated to reconstruct a surface of π-lines. The backprojection for each surface of the π-lines (indexed by Δ_{filt}) is executed over the interval X[λ_{filt}-YFOV/λ_{filt}+n+FOV], wherein YFOV=arcsin(RFOV/RO) with RFOV as the radius of the field of view. A method as it is described by F. Noo et al. in “Exact helical reconstruction using native cone-beam geometries”, Phys. Med. Biol., vol. 48, pp. 3787-3818, November 2003, Chapter 4.3.5, Equations 59 through 64 is used in order to deal with the dependency of the voxels on the region of the projections over which the backprojection is executed. This technique is likewise used in order to determine the limit values in Equation 14.

### 2) DBP-1:

The implementation of this variant corresponds to that of the Katesevich algorithm that is shown in F. Noo et al., “Exact helical reconstruction using native cone-beam geometries”, Phys. Med. Biol., vol. 48, pp. 3787-3818, November 2003, except for a replacement of the filter step with a derivation according to A given a fixed beam direction.

### 3) DBP-0:

The third approach to implement the DBP method is based on a rebinning of the measurement data in a pseudo-parallel geometry (“wedge” geometry) corresponding to

$$\begin{matrix}\partial ( λ , γ ) = λ + \frac{π}{2} - γ , & {s}_{r} ( λ , γ ) = {R}_{0} sin γ ,\end{matrix} \qquad EQ . 19$$

wherein ω is initially not changed during the rebinning. The backprojection formula after the rebinning can be described with

$$\begin{matrix}( Hf ) ( \underline{x} ) = - \frac{1}{2 π} {\int }_{{\partial }_{filt}}^{{\partial }_{filt} + π} \frac{D \cdot {\overline{g}}_{rb} ( \partial , {s}_{r}^{*} \underline{( \partial , \underline{x} )} , {w}^{*} ( \partial , \underline{x} ) )}{\sqrt{{D}^{2} + {( {w}^{*} ( \partial , \underline{x} ) )}^{2}}} \\ with & EQ . 20 \\ {\overline{g}}_{rb} = ( \partial , {s}_{r} , ω ) = \frac{\partial }{\partial {s}_{r}} {g}_{rebin} ( \partial , {s}_{r} , ω ) & EQ . 21 \\ {s}_{r}^{*} ( \partial , \underline{x} ) = x cos ( \partial + {\partial }_{0} ) + y sin ( \partial + {\partial }_{0} ) & EQ . 22 \\ {ω}^{*} ( \partial , \underline{x} ) = \frac{D ( z - {z}_{0} - h ( π / 2 + arcsin ( {s}_{r}^{*} / {R}_{0} ) ) )}{y cos ( \partial + {\partial }_{0} ) - x sin ( \partial + {\partial }_{0} ) + \sqrt{{R}_{0}^{2}} - {s}_{r}^{* 2}} & EQ . 23\end{matrix}$$

and ∂_{filt}=λ_{filt}+π/2 and ∂₀=λ₀+/2. As is seen here, this approach reduces the filtering to a simpler derivation according to ∂/∂sᵣ, which represents a great advantage for the implementation. Both the backprojection weighting and the voxel dependency of the backprojection range within a given surface of π-lines are eliminated. After deciding on an s,τ- or x,y-backprojection grid and calculation of the z-values of the voxels, the integration can additionally occur directly over the interval [∂_{filt},∂_{filt}+π].

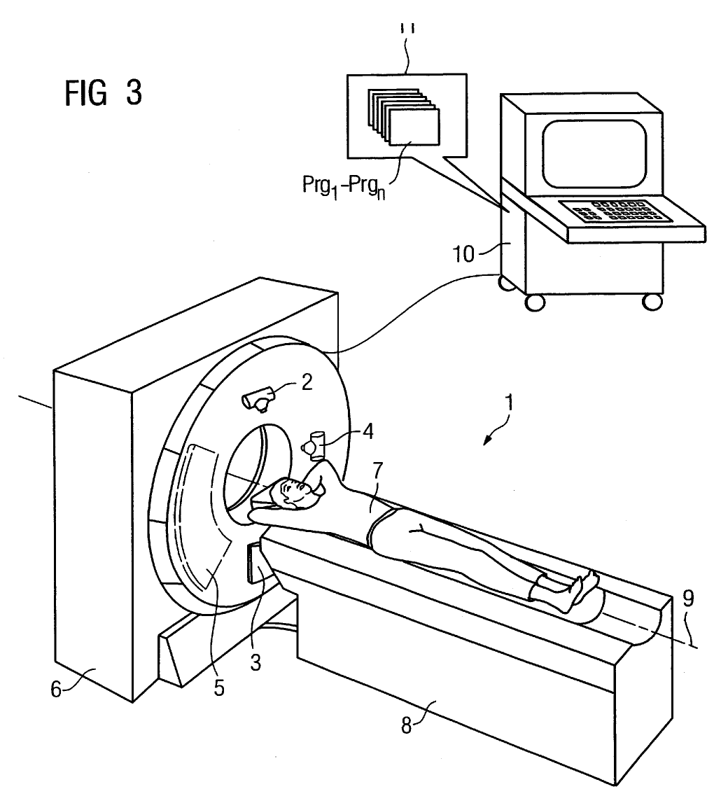

FIG. 3 shows an exemplary embodiment of a CT system 1 with which the method described above according to the invention can be implemented. The CT system 1 has a first tube/detector system with an x-ray tube 2 and a detector 3 situated opposite said x-ray tube 2. This CT system 1 can optionally have a second x-ray tube 4 with a detector 5 situated opposite said x-ray tube 4. Both tube/detector systems are located on a gantry that is arranged in a gantry housing 6 and rotates around a system axis 9 during the scanning. The patient 7 is located on a displaceable examination bed 8 that is shifted continuously along the system axis 9 through the scan field located in a round opening in the gantry housing 6, such that a helical scanning occurs relative to the patient, wherein the attenuation of the x-ray radiation emitted by the x-ray tubes is measured in a plurality of angle positions of x-ray tube and detector.

The control of the CT system ensues with a control and computation unit 10 in which are located computer programs Prg₁ through Prgₙ that can also implement the reconstruction methods according to the invention that are described in the preceding. The output of image data can also ensue via this control and computation unit 10. However, it is noted that the method according to the invention can also be implemented at workstations that merely receive measurement data of a remotely situated CT system.

In summary, the reconstruction method, CT apparatus and computer-readable medium encoded with programming instructions that are disclosed herein implement the image reconstruction along theoretical π-lines, wherein the theoretical π-lines not only lead to interpolated detector data but also can emanate from interpolated source positions. Interpolation thus occurs both at the detector and at the source.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for reconstruction of a computed tomography (CT) image from x-ray CT data sets of an examination subject, comprising the steps of:
scanning an examination subject on a spiral path using a CT system to acquire measured detector data;
from said measured detector data automatically electronically obtaining interpolated detector data; and
electronically reconstructing an image of the examination subject from said interpolated data and said measured data by differential backprojection followed by a Hilbert transformation over a surface formed by π-lines.

2. A method according to claim 1, comprising obtaining said interpolated data by interpolating between said measured data to cause π-lines belonging to actual detector data to appear in parallel when projected on a plane perpendicular to a z-axis forming the system axis of the CT system.

3. A method according to claim 2, comprising selecting data to be interpolated from among said measured detector data to form π-lines that are equidistant from one another.

4. A method according to claim 1 comprising conducting the backprojection over an (s,τ)-grid in a cylindrical (s,τ,λ_{filt})-coordinate grid, to obtain a final reconstruction by application of the inverse Hilbert transformation in the same geometry and by a subsequent interpolation of the final reconstruction on a Cartesian (x,y,z) coordinate grid, wherein the following relationship exists between the coordinates:
$$x = - s sin ( {λ}_{filt} + {λ}_{0} ) - τ cos ( {λ}_{filt} + {λ}_{0} ) , \\ y = s cos ( {λ}_{filt} + {λ}_{0} ) - τ sin ( {λ}_{filt} + {λ}_{0} ) , \\ z = {z}_{0} + h ( {λ}_{filt} + \frac{π}{2} + k ( s , τ ) ) , \\ with$$
$$k ( s , τ ) = \frac{τ ( π / 2 - arcsin ( s / {R}_{0} ) )}{\sqrt{{R}_{0}^{2} - {s}^{2}}}$$
and
R₀ is the radius of the spiral path.

5. A method according to claim 4 comprising forming derivatives for the differential backprojection exclusively in detector coordinates.

6. A method according to claim 4 comprising implementing the differential backprojection using a derivative according to the source position A given a fixed x-ray beam direction in space.

7. A method according to claim 4 comprising rebinning in wedge geometry before the backprojection, and conducting derivative formation and the backprojection in said wedge geometry.

8. A method according to claim 1 comprising conducting the backprojection on a surface of the π-lines across an (x,y)-grid in an (x,y,λ_{filt})-coordinate grid, and interpolating results of the backprojection in a cylindrical (s,τ,λ_{filt})-coordinate grid in order to implement the inverse Hilbert transformation, and interpolating the results of the backprojection on a Cartesian (x,y,z) coordinate grid, wherein the following relationship exists between the coordinates:
$$x = - s sin ( {λ}_{filt} + {λ}_{0} ) - τ cos ( {λ}_{filt} + {λ}_{0} ) , \\ y = s cos ( {λ}_{filt} + {λ}_{0} ) - τ sin ( {λ}_{filt} + {λ}_{0} ) , \\ z = {z}_{0} + h ( {λ}_{filt} + \frac{π}{2} + k ( s , τ ) ) , \\ with$$
$$k ( s , τ ) = \frac{τ ( π / 2 - arcsin ( s / {R}_{0} ) )}{\sqrt{{R}_{0}^{2} - {s}^{2}}}$$
and
R₀ is the radius of the spiral path.

9. A method according to claim 8 comprising forming derivatives for the differential backprojection exclusively in detector coordinates.

10. A method according to claim 8 comprising implementing the differential backprojection using a derivative according to the source position A given a fixed x-ray beam direction in space.

11. A method according to claim 8 comprising rebinning in wedge geometry before the backprojection, and conducting derivative formation and the backprojection in said wedge geometry.

12. A computed tomography (CT) apparatus comprising:
a CT scanner configured to scan an examination subject on a spiral path to acquire measured detector data; and
a processor configured to obtain interpolated detector data from said measured detector data, and to reconstruct an image of the examination subject from said interpolated data and said measured data by differential backprojection followed by a Hilbert transformation over a surface formed by π-lines.

13. A computer-readable medium encoded with programming instructions for reconstructing a computed tomography (CT) image from x-ray CT data sets of an examination subject acquired by scanning the examination subject on a spiral path using a CT system to acquire measured detector data, said computer-readable medium being loaded into a computer and causing said computer to:
from said measured detector data, obtain interpolated detector data; and
reconstruct an image of the examination subject from said interpolated data and said measured data by differential backprojection followed by a Hilbert transformation over a surface formed by π-lines.
